(19) United States
(12) Patent Application Publication
(10) Pub. No.: US 2024/0346558 A1
(43) Pub. Date: Oct. 17, 2024

(54) STORE SYSTEM, SERVER, AND METHOD THEREFOR

(71) Applicant: TOSHIBA TEC KABUSHIKI KAISHA, Tokyo (JP)

(72) Inventors: Takuya Kamitani, Mishima Shizuoka (JP); Yuishi Takeno, Numazu Shizuoka (JP); Tomonari Kakino, Fuji Shizuoka (JP); Keita Yamazaki, Mishima Shizuoka (JP); Thandar Mya, Yokohama Kanagawa (JP)

(21) Appl. No.: 18/500,307

(22) Filed: Nov. 2, 2023

(30) Foreign Application Priority Data
Apr. 11, 2023 (JP) 2023-064201

(51) Int. Cl. G06Q 30/0283; G06Q 20/20; G06Q 30/02; G06Q 30/0601

(52) U.S. Cl. CPC G06Q 30/0283; G06Q 20/201; G06Q 30/0281; G06Q 30/0633; G06Q 10/087

(57) ABSTRACT

A store system includes a server configured to manage a price-cut amount specified by a sticking object stuck to a commodity and an information terminal operated by a consumer visiting a store that sells the commodity. The server detects that the price-cut amount specified by the sticking object fluctuated according to elapse of time. The server distributes, to the information terminal, communication of which with the server is established, information indicating that the price-cut amount specified by the sticking object fluctuated. The information terminal informs, based on the information received from the server, that the price-cut amount specified by the sticking object fluctuated.

### CROSS-REFERENCE TO RELATED APPLICATION

This application is based upon and claims the benefit of priority from Japanese Patent Application No. 2023-064201, filed Apr. 11, 2023, the entire contents of which are incorporated herein by reference.

### FIELD

Embodiments described herein relate generally to a store system, a server of the system, and a method for the server.

### BACKGROUND

In stores such as a supermarket and a drug store, sticking objects such as indicating price-cut amounts or discount rates are stuck to price-cut target commodities. The commodities stuck with the sticking objects are sold at prices lower than fixed prices by the price-cut amounts or at the discount rates written on the sticking objects.

Usually, price-cut target commodities are commodities approaching their expiration dates or best-before dates or commodities to be subject to stock disposal. By price-cutting and selling the commodities, losses due to unsold commodities can be reduced. This effect is considered to be further enhanced by increasing price-cut amounts as the remaining times until the expiration dates or the best-before dates decrease or as the remaining times until the stock disposal decrease. On the other hand, in order to increase the price-cut amounts according to the remaining times, work for replacing the sticking objects is required. Further, cost increases because two or more kinds of sticking objects are necessary for one price-cut target commodity.

In order to solve such a problem, amounts of price-cuts decided by sticking objects only have to be able to be changed according to the elapse of time. However, if the price-cut amounts are changed according to the elapse of time, from when a consumer puts a commodity in a shopping basket or the like on a selling floor until the consumer checks out in a checkout place (a register), a price-cut amount decided by a sticking object stuck to the commodity is likely to be changed.

### BRIEF DESCRIPTION OF THE DRAWINGS

FIG. 1 is a block diagram illustrating an overall configuration of a store system;

FIG. 2 is a block diagram illustrating a main part circuit configuration of a mobile server;

FIG. 3 is a structure diagram of commodity master data stored in a commodity master;

FIG. 4 is a structure diagram of sticker master data stored in a sticker master;

FIG. 5 is a schematic diagram illustrating a configuration of data stored in a transaction file;

FIG. 6 is a block diagram illustrating a main part circuit configuration of a mobile terminal;

FIG. 7 is a block diagram illustrating a main part circuit configuration of a price-cut management server;

FIG. 8 is a schematic diagram illustrating data structure of a sticker-based table;

FIG. 9 is a flowchart illustrating a main part procedure of first information processing executed by a processor of the mobile terminal;

FIG. 10 is a flowchart illustrating a main part procedure of second information processing executed by a processor of the price-cut management server;

FIG. 11 is a flowchart illustrating a main part procedure of third information processing executed by the processor of the mobile terminal;

FIG. 12 is a flowchart illustrating a main part procedure of fourth information processing executed by a processor of the mobile server;

FIG. 13 is a screen example of a touch panel on which a price-cut amount update image and an updated total amount are displayed;

FIG. 14 is a block diagram illustrating a main part circuit configuration of the price-cut management server in a second embodiment;

FIG. 15 is a flowchart illustrating a main part procedure of first information processing executed by the processor of the mobile terminal in the second embodiment;

FIG. 16 is a flowchart illustrating a main part procedure of fifth information processing executed by the processor of the price-cut management server in the second embodiment; and

FIG. 17 is a flowchart illustrating a main part procedure of second information processing executed by the processor of the price-cut management server in the second embodiment.

### DETAILED DESCRIPTION

An aspect of embodiments is to provide a technique for enabling a consumer to easily learn that a price-cut amount decided by a sticking object was changed according to the elapse of time.

In one embodiment, a store system includes: a server configured to manage a price-cut amount specified by a sticking object stuck to a commodity; and an information terminal operated by a consumer visiting a store that sells the commodity.

The server includes a detecting unit and a distributing unit. The detecting unit detects that the price-cut amount specified by the sticking object fluctuated according to elapse of time. The distributing unit distributes, to the information terminal, communication of which with the server is established, information indicating that the price-cut amount specified by the sticking object fluctuated.

The information terminal includes a communication control unit and an informing unit. The communication control unit establishes communication with the server until checkout of a commodity purchased in the store by the consumer visiting the store ends. The informing unit informs, based on the information received from the server, that the price-cut amount specified by the sticking object fluctuated.

A store system in an embodiment that enables a consumer to easily learn that a price-cut amount decided by a sticking object was changed according to the elapse of time is explained below with reference to the drawings.

Note that this embodiment illustrates a case in which, in a store that treats a commodity, an expiration date of which is set in units of time, such as a box lunch or a salad as a price-cut target commodity, a price-cut amount of the price-cut target commodity is changed according to the remaining time until the expiration date. Specifically, a person in charge of a selling floor sticks, to a price-cut target commodity, the remaining time until an expiration date of which reaches a predetermined time, a sticking object for specifying a price-cut amount of the commodity. The store system changes, according to the elapse of time, a price-cut amount specified by the sticking object. The sticking object is a sticker having an adhesive surface. In this embodiment, the sticking object is represented as a price-cut sticker.

### First Embodiment

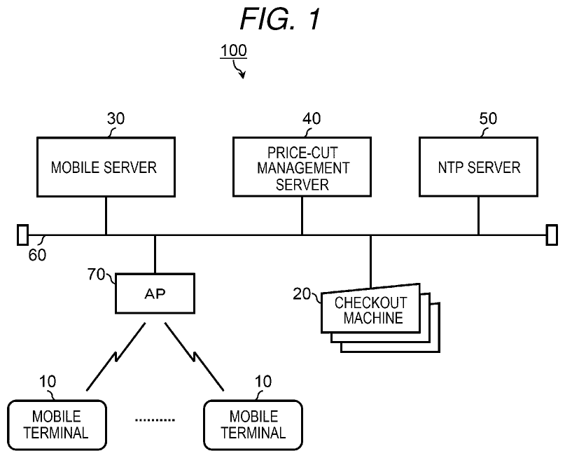

A first embodiment is explained with reference to FIGS. 1 to 13.

### [Explanation of a Store System]

First, an overview of a store system constructed in a store is explained with reference to FIG. 1.

FIG. 1 is a block diagram illustrating an overall configuration of a store system 100. The store system 100 includes a plurality of mobile terminals 10, a plurality of checkout machines 20, and a server group including a mobile server 30, a price-cut management server 40, and an NTP (Network Time Protocol) server 50. In the store system 100, the checkout machine 20 and the server group are connected via a communication network 60 such as a LAN (Local Area Network). In the store system 100, an access point 70 is connected to the communication network 60 to enable the access point 70 and the plurality of mobile terminals 10 to perform data communication by radio. Note that the number of access points 70 is not limited to one. Two or more access points 70 may be connected to the communication network 60 according to a size of a store, a layout of a selling floor, or the like. The server group is not limited to the mobile server 30, the price-cut management server 40, and the NTP server 50 explained above. Servers for other uses may be connected to the communication network 60.

A consumer visiting the store becomes an operator of the mobile terminal 10. The store is divided into a selling floor where commodities are displayed and a checkout place (a register) where checkout is performed. The consumer visiting the store moves in the selling floor together with the mobile terminal 10. If finding a commodity that the consumer desires to purchase, a so-called purchase commodity, the consumer operates the mobile terminal 10 by himself or herself to register the purchase commodity and puts the registered purchase commodity in a shopping basket or the like. In this way, the mobile terminal 10 is a wireless communication terminal used in a self-service registration system of a selling floor moving type. For example, a general-purpose smartphone owned by the consumer, a dedicated handy terminal rent out to the consumer by the store, a tablet terminal attached to a shopping cart, and the like can be the mobile terminal 10.

The checkout machine 20 is electronic equipment that processes checkout of the consumer who registered the purchase commodity by himself or herself using the mobile terminal 10. The checkout may be performed by cash and may be performed by cashless means such as a credit card, electronic money, or code settlement. The checkout machine 20 may be a self-service-type checkout machine with which the consumer performs checkout operation by himself or herself or may be a facing-type checkout machine with which a casher, who is an employee of the store, performs checkout operation.

The mobile server 30 is a computer system that performs a service for supporting registration of a purchase commodity by the mobile terminal 10. The price-cut management server 40 is a computer system that performs a service for managing a price-cut amount specified by a price-cut sticker. The NTP server 50 is a computer system that performs a service for acquiring correct time information and distributing the time information to the other servers and the like connected to the communication network 60. The server group may provide the services under an on-premise environment or may provide the services under a Cloud computing environment.

### [Explanation of the Mobile Server]

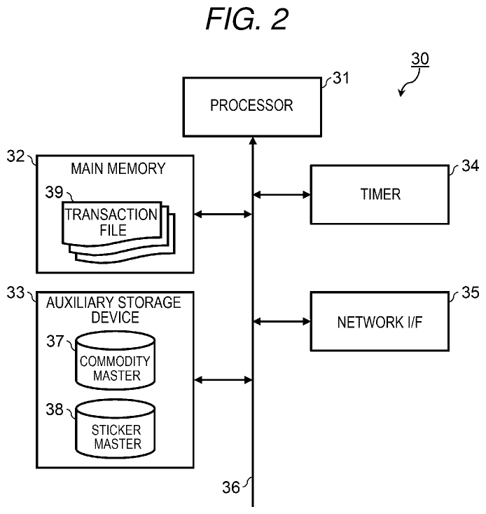

Next, the mobile server 30 is explained with reference to FIGS. 2 to 5.

FIG. 2 is a bock diagram illustrating a main part circuit configuration of the mobile server 30. The mobile server 30 includes a processor 31, a main memory 32, an auxiliary storage device 33, a timer 34, a network interface 35, and a system transmission line 36. The system transmission line 36 includes an address bus, a data bus, and a control signal line. The system transmission line 36 connects the processor 31 and the other units and transmits data signals exchanged between the processor 31 and the other units.

In the mobile server 30, the processor 31, the main memory 32, and the auxiliary storage device 33 are connected by the system transmission line 36 to configure a computer. In the mobile server 30, the timer 34 and the network interface 35 are connected to the system transmission line 36 and controlled by the computer to implement functions of the mobile server 30.

The processor 31 is equivalent to a central part of the computer. The processor 31 controls the units in order to implement various functions of the mobile server 30 according to an operating system or application programs. The processor 31 is, for example, a CPU (Central Processing Unit). The processor 31 is a multicore processor that includes a plurality of processor cores and is capable of executing a plurality of kinds of processing in parallel.

The main memory 32 is equivalent to a main storage part of the computer. The main memory 32 includes a nonvolatile memory region and a volatile memory region. The main memory 32 stores the operating system or the application programs in the nonvolatile memory region. The main memory 32 sometimes stores, in the nonvolatile or volatile memory region, data necessary for the processor 31 in executing processing for controlling the units. The main memory 32 uses the volatile memory region as a work area where data is rewritten by the processor 31 as appropriate. The nonvolatile memory region is, for example, a ROM (Read Only Memory). The volatile memory region is, for example, a RAM (Random Access Memory).

The auxiliary storage device 33 is equivalent to an auxiliary storage part of the computer. For example, an EEPROM (Electric Erasable Programmable Read-Only Memory), a HDD (Hard Disk Drive), or an SSD (Solid State Drive) can be the auxiliary storage device 33. The auxiliary storage device 33 stores data to be used by the processor 31 in performing various kinds of processing, data generated by the processing in the processor 31, and the like. The auxiliary storage device 33 sometimes stores the application programs described above.

The timer 34 tracks present time in synchronization with the time information distributed from the NTP server 50.

The network interface 35 is an interface for performing data communication with other equipment connected to the communication network 60. The other equipment includes the mobile terminals 10, wireless communication of which established with the price-cut management server 40, the NTP server 50, and the access point 70.

The mobile server 30 having such a configuration manages databases of a commodity master 37 and a sticker master 38 in the auxiliary storage device 33. The mobile server 30 temporarily stores a plurality of transaction files 39 in the main memory 32.

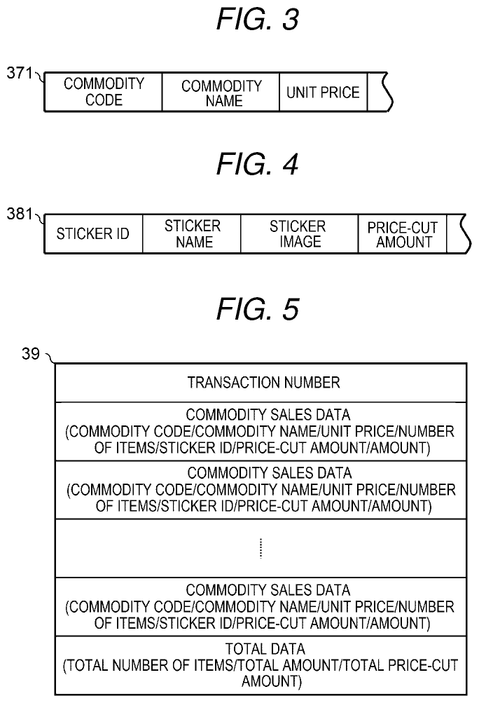

The commodity master 37 is an aggregate of commodity master data 371 (see FIG. 3) generated for each of commodities sold in the store. The commodity master data 371 is, as illustrated in FIG. 3, a record configured by data of items such as a commodity code, a commodity name, and a price. The commodity code is unique identification information set for each of the commodities in order to individually identify the commodities. Usually, commodity codes for identifying the commodities are attached to the commodities in a form of barcodes. The commodity codes may be attached to the commodities in a form of two-dimensional codes. RFID (Radio Frequency Identification) tags storing the commodity codes in IC memories may be attached to the commodities. The unit price is a normal price per one commodity. The unit price is considered a fixed price as well.

The sticker master 38 is an aggregate of sticker master data 381 (see FIG. 4) generated for each of types of price-cut stickers stuck to price-cut target commodities. The sticker master data 381 is, as illustrated in FIG. 4, a record configured by data of items such as a sticker ID, a sticker name, a sticker image, and a price-cut amount. The sticker ID is unique identification information set for each of price-cut stickers in order to identify various price-cut stickers. The sticker name is a name set for a price-cut sticker identified by the sticker ID. The sticker image is an image printed on the surface on the opposite side of an adhesive surface of the price-cut sticker identified by the sticker ID. The price-cut amount is an initial price-cut amount specified by the price-cut sticker identified by the sticker ID.

The transaction file 39 is, as illustrated in FIG. 5, a region for storing a transaction number, one or a plurality of commodity sales data, and total data. The transaction number is a unique number generated every time a sales transaction with a consumer who operates the mobile terminal 10 and registers a purchase commodity by himself or herself is performed. At least transaction numbers do not overlap in a plurality of transaction files 39 stored in the mobile server 30.

The commodity sales data is information relating to a purchase commodity registered in a sales transaction specified by the transaction number. The commodity sales data includes data of items such as a commodity code, a commodity name, a unit price, the number of items, a sticker ID, a price-cut amount, and an amount. The commodity code, the commodity name, and the unit price are information of the commodity master data 371. The number of items is the number of purchased items of a purchase commodity identified by the commodity code. The sticker ID and the price-cut amount are information based on a price-cut sticker stuck to the purchase commodity. If a price-cut sticker is not attached to the purchase commodity, the sticker ID and the price-cut amount are NULL value or “0”. The amount is an amount obtained by subtracting the price-cut amount from an amount calculated by multiplying the unit price by the number of purchased items.

The total data includes a total number of items, a total amount, and a total price-cut amount. The total number of items is obtained by totaling the numbers of items of the commodity sales data stored in the transaction file 39. The total amount is obtained by totaling amounts of the commodity sales data stored in the transaction file 39. The total price-cut amount is obtained by totaling price-cut amounts of the commodity sales data stored in the transaction file 39.

### [Explanation of the Mobile Terminal]

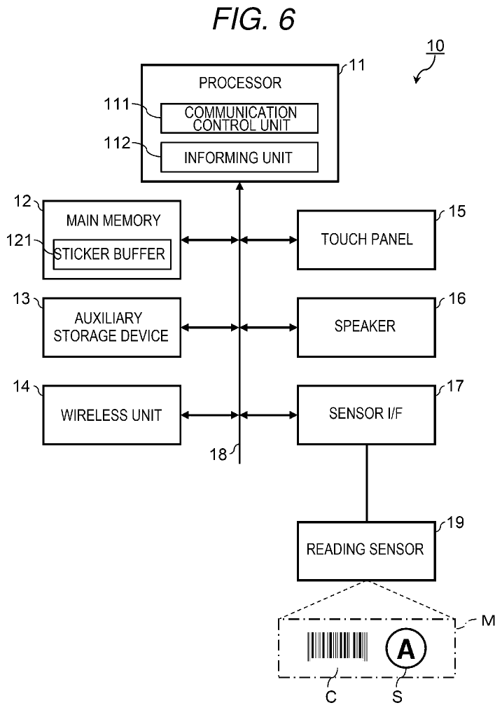

Next, a configuration of the mobile terminal 10 is explained with reference to FIG. 6.

FIG. 6 is a block diagram illustrating a main part circuit configuration of the mobile terminal 10. The mobile terminal 10 includes a processor 11, a main memory 12, an auxiliary storage device 13, a wireless unit 14, a touch panel 15, a speaker 16, a sensor interface 17, and a system transmission line 18. The system transmission line 18 includes an address bus, a data bus, and a control signal line. The system transmission line 18 connects the processor 11 and the other units and transmits data signals exchanged between the processor 11 and the other units.

In the mobile terminal 10, the processor 11, the main memory 12, and the auxiliary storage device 13 are connected by the system transmission line 18 to configure a computer. In the mobile terminal 10, the wireless unit 14, the touch panel 15, the speaker 16, and the sensor interface 17 are connected to the system transmission line 18 and controlled by the computer to implement functions of the mobile terminal 10. The mobile terminal 10 is an example of an information terminal in the store system 100.

The processor 11 is equivalent to a central part of the computer. The processor 11 controls the units in order to implement various functions of the mobile terminal 10 according to an operating system or application programs. The processor 11 is, for example, a CPU.

The main memory 12 is equivalent to a main storage part of the computer. The main memory 12 includes a nonvolatile memory region and a volatile memory region. The main memory 12 stores the operating system or the application programs in the nonvolatile memory region. The main memory 12 sometimes stores, in the nonvolatile or volatile memory region, data necessary for the processor 11 in executing processing for controlling the units. The main memory 12 uses the volatile memory region as a work area where data is rewritten as appropriate by the processor 11. The nonvolatile memory region is, for example, a ROM. The volatile memory region is, for example, a RAM.

The auxiliary storage device 13 is equivalent to an auxiliary storage part of the computer. For example, an EEPROM, a HDD, or an SSD can be the auxiliary storage device 13. The auxiliary storage device 13 stores data used by the processor 11 in performing various kinds of processing, data generated by the processing in the processor 11, and the like. The auxiliary storage device 13 sometimes stores the application programs explained above.

The wireless unit 14 is a unit for performing transmission and reception of data to and from the access point 70 according to a predetermined wireless communication protocol. The touch panel 15 functions as a display device and an input device of the mobile terminal 10. The speaker 16 is a speaker for emitting various alarm sounds. The speaker 16 may emit voice synthesized by a voice synthesizing system.

The sensor interface 17 is a communication interface with a reading sensor 19. The reading sensor 19 is a sensor having a function of reading a barcode C and a price-cut sticker S attached to a commodity M. For example, the reading sensor 19 disconnects out an image of the barcode C and an image of the price-cut sticker S from an image of the commodity M captured by a camera. The reading sensor 19 outputs image data of the barcode C and image data of the price-cut sticker S to the sensor interface 17. Here, the reading sensor 19 connected to the sensor interface 17 functions as a reading unit that reads a sticking object, that is, the price-cut sticker S stuck to the commodity.

The mobile terminal 10 having such a configuration is installed with dedicated application software in order to support self-service registration of a purchase commodity by a consumer, who is an operator. In the following explanation, this software is referred to as self-service registration application. A method of installing the self-service registration application in the main memory 12 or the auxiliary storage device 13 is not particularly limited. The self-service registration application can be installed in the main memory 12 or the auxiliary storage device 13 by being recorded in a removable recording medium or being distributed by communication via a network. A form of the recording medium does not matter if the recording medium can store programs and can be read by a device like a CD-ROM or a memory card.

The mobile terminal 10 installed with the self-service registration application sets a part of the volatile storage region of the main memory 12 as a region of a sticker buffer 121. The sticker buffer 121 is a region for temporarily storing a sticker ID of the price-cut sticker S read by the reading sensor 19.

The processor 11 of the mobile terminal 10 installed with the self-service registration application implements functions of a communication control unit 111 and an informing unit 112. The communication control unit 111 is a function of establishing communication with the price-cut management server 40 until checkout of a purchase commodity purchased in the store by the consumer visiting the store ends. The informing unit 112 is a function of informing, based on information received from the price-cut management server 40, that a price-cut amount specified by the price-cut sticker S fluctuated.

### [Explanation of a Configuration of the Price-Cut Management Server]

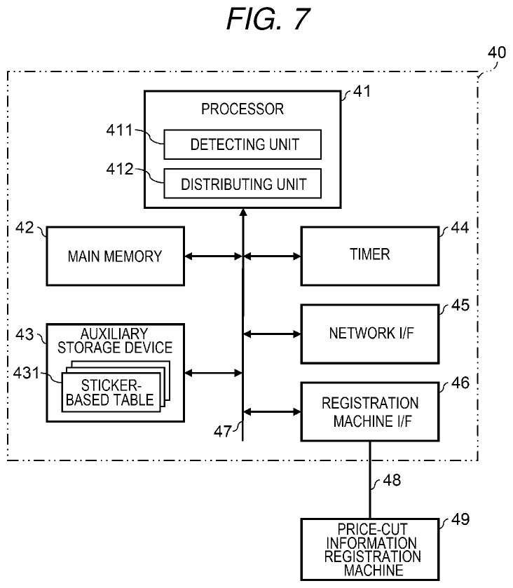

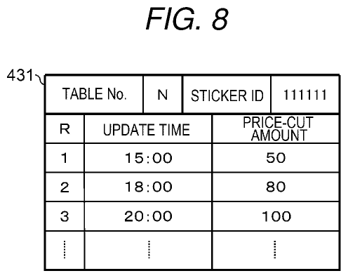

Next, a configuration of the price-cut management server 40 is explained with reference to FIGS. 7 and 8.

FIG. 7 is a block diagram illustrating a main part circuit configuration of the price-cut management server 40. The price-cut management server 40 includes a processor 41, a main memory 42, an auxiliary storage device 43, a timer 44, a network interface 45, a registration machine interface 46, and a system transmission line 47. The system transmission line 47 includes an address bus, a data buss, and a control signal line. The system transmission line 47 connects the processor 41 and the other units and transmits data signals exchanged between the processor 41 and the other units.

In the price-cut management server 40, the processor 41, the main memory 42, and the auxiliary storage device 43 are connected by the system transmission line 47 to configure a computer. In the price-cut management server 40, the timer 44, the network interface 45, and the registration machine interface 46 are connected to the system transmission line 47 and controlled by the computer to implement functions of the price-cut management server 40. The price-cut management server 40 is an example of servers in the store system 100.

The processor 41 is equivalent to a central part of the computer. The processor 41 controls the units in order to implement various functions of the price-cut management server 40 according to an operating system or application programs. The processor 41 is, for example, a CPU. The processor 41 is a multicore processor that includes a plurality of processor cores and is capable of executing a plurality of kinds of processing in parallel.

The main memory 42 is equivalent to a main storage part of the computer. The main memory 42 includes a nonvolatile memory region and a volatile memory region. The main memory 42 stores system or the the operating application programs in the nonvolatile memory region. The main memory 42 sometimes stores, in the nonvolatile or volatile memory region, data necessary for the processor 41 in executing processing for controlling the units. The main memory 42 uses the volatile memory region as a work area where data is rewritten as appropriate by the processor 41. The nonvolatile memory region is, for example, a ROM. The volatile memory region is, for example, a RAM.

The auxiliary storage device 43 is equivalent to an auxiliary storage part of the computer. For example, an EEPROM, a HDD, or an SSD can be the auxiliary storage device 43. The auxiliary storage device 43 stores data used by the processor 41 in performing various kinds of processing, data generated by the processing in the processor 41, and the like. The auxiliary storage device 43 sometimes stores the application programs explained above.

The timer 44 tracks the present time in synchronization with the time information distributed from the NTP server 50.

The network interface 45 is an interface for performing data communication with the other equipment connected to the communication network 60. The other equipment includes the mobile terminals 10, wireless communication of which is established with the mobile server 30, the NTP server 50, and the access point 70.

The registration machine interface 46 is an interface for performing data communication with a price-cut information registration machine 49 detachably connected by a communication cable 48. The price-cut information registration machine 49 is equipment for registering, in the price-cut management server 40, information concerning a price-cut amount specified by a price-cut sticker. For example, a general-purpose personal computer is used as the price-cut information registration machine 49.

The price-cut management server 40 having such a configuration is installed with dedicated application software in order to centrally manage information concerning price-cut amounts respectively specified by various price-cut stickers. In the following explanation, this software is referred to as price-cut management application. A method of installing the price-cut management application in the main memory 42 or the auxiliary storage device 43 is not particularly limited. The price-cut management application can be installed in the main memory 42 or the auxiliary storage device 43 by being recorded in a removable recording medium or being distributed by communication via a network. A form of the recording medium does not matter if the recording medium can store programs and can be read by a device like a CD-ROM or a memory card.

The price-cut management server 40 installed with the price-cut management application sets a part of a storage region of the auxiliary storage device 43 as a region of a sticker-based table 431. The sticker-based table 431 is a data table prepared for each of types of price-cut stickers.

FIG. 8 is a schematic diagram illustrating data structure of the sticker-based table 431. As illustrated in FIG. 8, the sticker-based table 431 describes a table number N and a sticker ID as header information. The sticker-based table 431 includes a column of a record number R, a column of update time, and a column of a price-cut amount.

The table number N is a serial number starting from “1” allocated to individually identify the sticker-based table 431. The sticker ID is identification information of a price-cut sticker for which the sticker-based table 431 is used. The record number R is a serial number starting from “1” allocated to each of pair data of the update time and the price-cut amount described in the column of the update time and the column of the price-cut amount corresponding to the record number R. Pair data of update time and price-cut amount corresponding to the record number R of “1” is time when the price-cut sticker identified by the sticker ID is stuck to a price-cut target commodity and a price-cut amount at that point in time, that is, an initial price-cut amount. Pair data of update time and a price-cut amount corresponding to the record number R of “2” or more are time when the price-cut amount specified by the price-cut sticker identified by the sticker ID is updated and a price-cut amount after the update. A plurality of pair data of update time and a price-cut amount can be set in ascending order of record numbers R. The price-cut information registration machine 49 sets the update time and the price-cut amount.

Referring back to FIG. 7, the processor 41 of the price-cut management server 40 installed with the price-cut management application implements functions of a detecting unit 411 and a distributing unit 412. The detecting unit 411 is a function of detecting that a price-cut amount specified by a price-cut sticker fluctuated according to the elapse of time. The distributing unit 412 is a function of distributing information indicating that the price-cut amount specified by the price-cut sticker fluctuated to information terminals, communication of which with the price-cut management server 40 is established, that is, the mobile terminals 10.

### [Explanation of an Operation of the Store System]

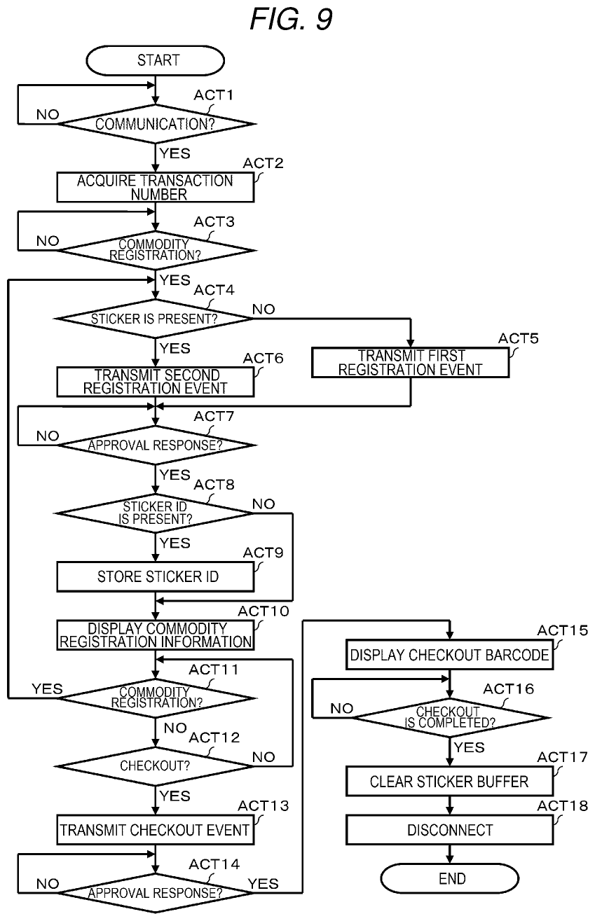

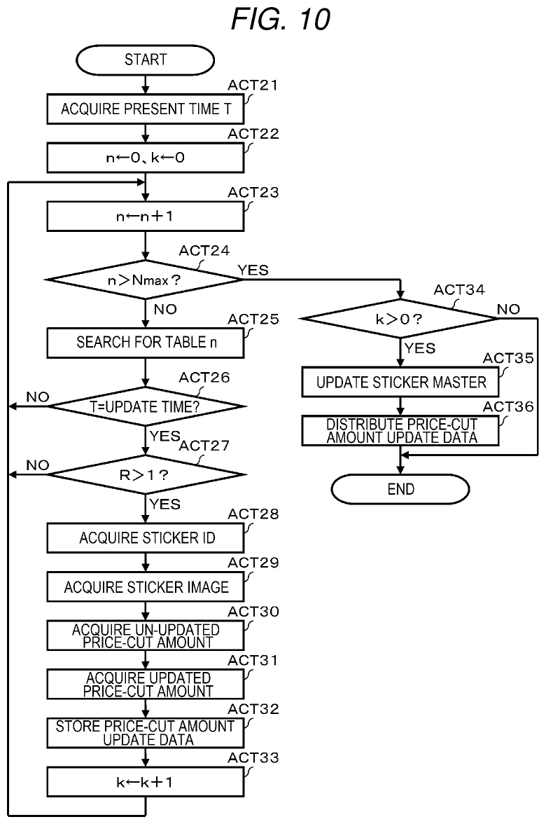

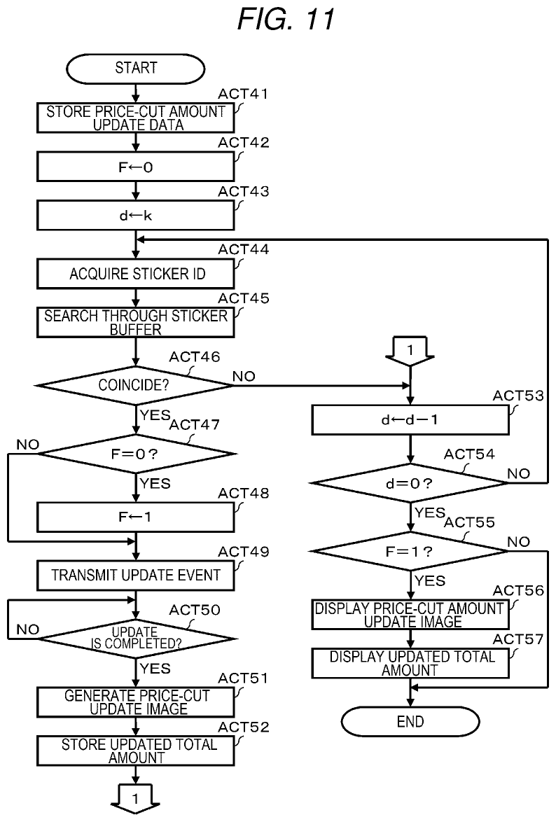

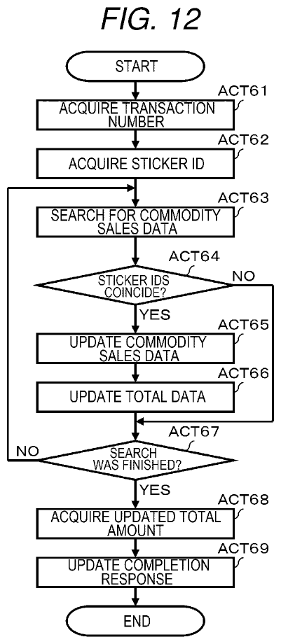

Next, a main operation of the store system 100 is explained with reference to flowcharts of FIGS. 9 to 12. FIGS. 9 and 11 are flowcharts illustrating a main part procedure of information processing executed by the processor 11 of the mobile terminal 10. FIG. 10 is a flowchart illustrating a main part procedure of information processing executed by the processor 41 of the price-cut management server 40. FIG. 12 is a flowchart illustrating a main part procedure of information processing executed by the processor 31 of the mobile server 30. Note that the procedures of the information processing explained below are examples. If the same action effects can be achieved, the procedures are not limited.

### [First Information Processing]

A consumer who registers a purchase commodity by himself or herself using the mobile terminal 10 starts a self-service registration application after coming to the store. If the self-service registration application is started, the processor 11 of the mobile terminal 10 starts the information processing of the procedure illustrated in the flowchart of FIG. 9. In the following explanation, this processing is referred to as first information processing.

In ACT 1, the processor 11 waits for communication with the mobile server 30 to be established via the access point 70. If the communication with the mobile server 30 is established by an operation of the wireless unit 14, since a new transaction number is transmitted from the mobile server 30, in ACT 2, the processor 11 acquires and stores the transaction number. Thereafter, in ACT 3, the processor 11 waits for registration of a purchase commodity.

For example, a start button is displayed on the touch panel 15 of the mobile terminal 10, communication of which with the mobile server 30 is established. The consumer touches the start button and starts shopping. The consumer moves in the selling floor and, if finding a purchase commodity, operates the mobile terminal 10 to register the purchase commodity. That is, the consumer reads a barcode of the purchase commodity with the reading sensor 19. If a price-cut sticker is stuck to the purchase commodity, the consumer reads an image of the price-cut sticker with the reading sensor 19. The consumer puts the registered commodity in a shopping basket or the like.

The processor 11, which detected the registration of the purchase commodity, proceeds from ACT 3 to ACT 4. In ACT 4, the processor 11 checks whether the image of the price-cut sticker is read. If the image of the price-cut sticker is not read, the processor 11 proceeds from ACT 4 to ACT 5. In ACT 5, the processor 11 controls transmission of a first registration event. In contrast, if the image of the price-cut sticker is read, the processor 11 proceeds from ACT 4 to ACT 6. In ACT 6, the processor 11 controls transmission of a second registration event.

According to the control explained above, the first registration event or the second registration event are wirelessly transmitted via the wireless unit 14. The wirelessly-transmitted first registration event or second registration event is received by the access point 70 and transmitted to the mobile server 30 through the communication network 60. The first registration event includes a commodity code obtained by analyzing the barcode read by the reading sensor 19. The second registration event includes the commodity code and image data of the price-cut sticker read by the reading sensor 19. The first registration event and the second registration event also include the transaction number stored in ACT 2.

The processor 31 of the mobile server 30, which received the first registration event, searches through the commodity master 37 with the commodity code included in the event and acquires the commodity master data 371 including the commodity code. The processor 31 generates commodity sales data with a commodity code, a commodity name, and a unit price of the commodity master data 371. The number of items of the commodity sales data is “1”. A sticker ID and a price-cut amount of the commodity sales data are NULL values or “0”. An amount of the commodity sale data is an amount obtained by multiplying the unit price by the number of items. The processor 31 describes the commodity sales data in the transaction file 39 in which the transaction number included in the first registration event is set.

On the other hand, the processor 31 of the mobile server 30, which received the second registration event, searches through the commodity master 37 with the commodity code included in the event and acquires the commodity master data 371 including the commodity code. The processor 31 searches through the sticker master 38 with the image data of the price-cut sticker included in the second registration event and acquires the sticker master 381 including similar sticker image data. The processor 31 generates commodity sales data with a commodity code, a commodity name, and a unit price of the commodity master data 371 and a sticker ID and a price-cut amount of the sticker master data 381. The number of items of the commodity sales data is “1”. An amount of the commodity sales data is an amount obtained by subtracting the price-cut amount from an amount obtained by multiplying the unit price by the number of items. The processor 31 describes the commodity sales data in the transaction file 39 in which the transaction number included in the second registration event is set.

The processor 31, which finished describing the commodity sales data in the transaction file 39, returns an approval response command to the mobile terminal 10 that is a transmission source of the first registration event or the second registration event. The approval response command includes the commodity sales data.

In ACT 7, the processor 11 of the mobile terminal 10, which transmitted the first registration event or the second registration event, waits for the approval response command. If receiving the approval response command from the mobile server 30 via the wireless unit 14, the processor 11 proceeds from ACT 7 to ACT 8. In ACT 8, the processor 11 checks whether a sticker ID is present in the commodity sales data included in the approval response command. If a value of a sticker ID is a NULL value or “0”, a sticker ID is absent. In this case, the processor 11 skips processing in ACT 9 and proceeds to ACT 10.

On the other hand, if a sticker ID is present in the commodity sales data, the processor 11 proceeds from ACT 8 to ACT 9. In ACT 9, the processor 11 stores the sticker ID in the sticker buffer 121. Thereafter, the processor 11 proceeds to ACT 10. Note that the sticker buffer 121 was cleared at a stage when the self-service registration application was started.

If storing the sticker ID in the sticker butter in ACT 9 or skipping the processing in ACT 9, in ACT 10, the processor 11 displays commodity registration information on the touch panel 15. The commodity registration information is information such as a commodity name, a unit price, the number of items, a price-cut amount, and an amount of the commodity sales data included in the approval response command. Note that, if a sticker ID is absent, the price-cut amount is displayed as “0”.

The processor 11, which displayed the commodity registration information, proceeds to ACT 11. In ACT 11, the processor 11 checks whether registration of the purchase commodity was performed. If registration of the purchase commodity was not performed, the processor 11 proceeds to ACT 12. In ACT 12, the processor 11 checks whether checkout was instructed. If checkout was not instructed, the processor 11 returns to ACT 11. In this way, in ACT 11 and ACT 12, the processor 11 waits for registration of the purchase commodity to be performed or checkout to be instructed.

If finding the next purchase commodity, the consumer operates the mobile terminal 10 to register the purchase commodity. If finishing the shopping, the consumer touches a checkout button displayed on the touch panel 15 and instructs checkout.

The processor 11, which detected the registration of the purchase commodity in the waiting state in ACT 11 and ACT 12, returns to ACT 4. The processor 11 executes the processing in ACT 4 to ACT 10 in the same manner as explained above. Therefore, in the mobile server 30, processing for describing the commodity sales data of the purchase commodity registered by the mobile terminal 10 in the transaction file 39 having the transaction number stored by the mobile terminal 10 is repeated based on the first registration event or the second registration event received from the mobile terminal 10. In the mobile terminal 10, processing for describing, if a price-cut sticker is stuck to the purchase commodity, a sticker ID of the price-cut sticker in the sticker buffer 121 is repeated.

The processor 11, which detected the checkout instruction in the waiting state in ACT 11 and ACT 12, proceeds to ACT 13. In ACT 13, the processor 11 controls transmission of a checkout event. According to the control, the checkout event is wirelessly transmitted via the wireless unit 14. The wirelessly-transmitted checkout event is received by the access point 70 and transmitted to the mobile server 30 through the communication network 60. The checkout event includes the transaction number stored in ACT 2.

The processor 31 of the mobile server 30, which received the checkout event, describes total data in the transaction file 39 having the transaction number included in the event. The total data is values obtained by respectively totaling numbers of items, amounts, and price-cut amounts of all commodity sales data described in the transaction file 39. The processor 31, which finished describing the total data in the transaction file 39, returns an approval response command to the mobile terminal 10 that is a transmission source of the checkout event. The approval response command includes data of a checkout barcode. The checkout barcode is obtained by, for example, converting the transaction number of the transaction file 39 into a barcode with a predetermined code system.

In ACT 14, the processor 11 of the mobile terminal 10, which transmitted the checkout event, waits for the approval response command. If receiving the approval response command from the mobile server 30 via the wireless unit 14, the processor 11 proceeds from ACT 14 to ACT 15. In ACT 15, the processor 11 displays the checkout barcode on the touch panel 15 based on the data included in the approval response command.

The consumer, who checked the checkout barcode, moves to the checkout place and causes a scanner of the checkout machine 20 to read the checkout barcode. The checkout machine 20, which read the checkout barcode, accesses the mobile server 30 via the communication network 60 and requests the transaction file 39 having the transaction number represented by the checkout barcode. The processor 31 of the mobile server 30, which received the request, outputs the relevant transaction file 39 to the checkout machine 20. Consequently, in the checkout machine 20, it is possible to perform settlement of a commercial transaction based on the data of the transaction file 39. Therefore, the consumer performs settlement. The processor 31 of the mobile server 30 transmits a checkout completion command to the mobile terminal 10 that transmitted the checkout event including the transaction number of the transaction file 39.

In ACT 16, the processor 11 of the mobile terminal 10, which displayed the checkout barcode, waits for the checkout completion command. If receiving the checkout completion command from the mobile server 30, the processor 11 proceeds from ACT 16 to ACT 17. In ACT 17, the processor 11 clears the sticker buffer 121. Thereafter, in ACT 18, the processor 11 disconnects a line to the mobile server 30 and ends the first information processing. Here, the processor 11 implements a function of the communication control unit 111 according to the processing in ACT 1 and ACT 18 in the first information processing.

### [Second Information Processing]

The processor 41 of the price-cut management server 40 starts information processing of a procedure illustrated in a flowchart of FIG. 10 every time, for example, one minute passed as the time tracked by the timer 44. In the following explanation, this processing is referred to as second information processing.

In ACT 21, the processor 41, which started the second information processing, acquires present time T tracked by the timer 44. In ACT 22, the processor 41 resets an addition counter n and an addition counter k respectively to “0”. The addition counter n counts the table number N of the sticker-based table 431. The addition counter k counts the number of data of price-cut amount update data explained below.

In ACT 23, the processor 41 counts up the addition counter n by “1”. In ACT 24, the processor 41 checks whether the addition counter n indicates a value larger than an upper limit value Nmax. The upper limit value Nmax is a maximum value of the table number N described in the sticker-based table 431. That is, the upper limit value Nmax is considered a total number of sticker-based tables 431 or the number of kinds of price-cut stickers.

If the addition counter n does not indicate a value larger than the upper limit value Nmax, the processor 41 proceeds from ACT 24 to ACT 25. In ACT 25, the processor 41 searches for the sticker-based table 431, the table number N of which coincides with a value of the addition counter n. In ACT 26, the processor 41 checks whether pair data of a price-cut amount and update time, which is the present time T, is described in the sticker-based table 431. In the following explanation, the pair data of the price-cut amount and the update time, which is the present time T, is referred to as updated pair data. If the updated pair data is not described, the processor 41 returns to ACT 23. The processor 41 further counts up the addition counter n by “1” and executes the processing in ACT 23 and subsequent acts in the same manner as explained above.

On the other hand, if the updated pair data is described, the processor 41 proceeds from ACT 26 to ACT 27. In ACT 27, the processor 41 discriminates whether the record number R of the updated pair data is “1” or larger than “1”. If the record number R is “1”, the updated pair data is time when a price-cut sticker was stuck to a price-cut target commodity and an initial price-cut amount. In this case, the processor 41 returns to ACT 23. The processor 41 further counts up the addition counter n by “1” and executes the processing in ACT 23 and subsequent acts in the same manner as explained above.

In contrast, if the record number R of the updated pair data is larger than “1”, that is, if the record number R is “2” or more, the updated pair data is time when a price-cut amount specified by a price-cut sticker is updated and the price-cut amount after the update. In this case, the processor 41 proceeds from ACT 27 to ACT 28. In ACT 28, the processor 41 acquires a sticker ID of the sticker-based table 431. In ACT 29, the processor 41 searches through the sticker master 38 and acquires sticker image data from the sticker master data 381 including the sticker ID acquired in the processing in ACT 28. In ACT 30, the processor 41 acquires a price-cut amount from the sticker master data 381. In the following explanation, this price-cut amount is referred to as un-updated price-cut amount. Further, in ACT 31, the processor 41 acquires a price-cut amount of the updated pair data. In the following explanation, this price-cut amount is referred to as updated price-cut amount.

If ending the processing in ACT 28 to ACT 31, the processor 41 proceeds to ACT 32. In ACT 32, the processor 41 generates price-cut amount update data and stores the price-cut amount update data in a transmission buffer. The price-cut amount update data is data including the sticker ID acquired in the processing in ACT 28, the sticker image acquired in the processing in ACT 29, the un-updated price-cut amount acquired in the processing in ACT 30, and the updated price-cut amount acquired in the processing in ACT 31. The price-cut amount update data is an example of information indicating that a price-cut amount specified by a price-cut sticker fluctuated. The transmission buffer is a part of a storage region secured in the main memory 42. The transmission buffer can temporarily store a plurality of price-cut amount update data.

The processor 41, which stored the price-cut amount update data, proceeds to ACT 33. In ACT 33, the processor 41 counts up the addition counter k by “1”. Thereafter, the processor 41 returns to ACT 23. The processor 41 further counts up the addition counter n by “1” and executes the processing in ACT 23 and subsequent acts in the same manner as explained above.

As explained above, the processor 41 sequentially searches for the sticker-based table 431 and, if pair data, the record number R of which is “2” or more, the pair data being pair data of a price-cut amount and update time, which is the present time T, is described, repeatedly executes processing for generating price-cut amount update data and storing the price-cut amount update data in the transmission buffer. If the addition counter n indicates a value larger than the upper limit value Nmax in ACT 24, the processor 41 proceeds to ACT 34. In ACT 34, the processor 41 checks whether the addition counter k indicates a value larger than “0”. If the addition counter k indicates “0”, that is, price-cut amount update data is not generated, the processor 41 ends the second information processing.

In contrast, if the addition counter k indicates a value larger than “0”, that is, at least one price-cut amount update data is generated, the processor 41 proceeds from ACT 34 to ACT 35. In ACT 35, the processor 41 requests, with the price-cut amount update data stored in the transmission buffer, the mobile server 30 to update the sticker master 38. In response to the request, the mobile server 30 updates a price-cut amount of the sticker master data 381 in which a sticker ID included in the price-cut updated data is described among the sticker master data 381 stored in the sticker master 38 to an updated price-cut amount of the price-cut amount update data.

The processor 41, which requested the update of the sticker master 38, proceeds to ACT 36. In ACT 36, the processor 41 distributes the price-cut amount update data stored in the transmission buffer to all the mobile terminals 10, communication of which is established via the access point 70. Consequently, the price-cut amount update data is wirelessly transmitted via the access point 70. The price-cut amount update data is received by all the mobile terminals 10, lines of which to the price-cut management server 40 are established. Then, the processor 41 ends the second information processing.

As explained above, if pair data, the record number R of which described in the sticker-based table 431 is “2” or more, the pair data being pair data with a price-cut amount, the update time of which is the present time T, is present, that is, an amount of a price-cut decided by a price-cut sticker was changed according to the elapse of time, a price-cut amount update data including a sticker ID and a sticker image of the price-cut sticker and an un-updated price-cut amount and an updated price-cut amount is generated. The sticker master 38 is updated based on the price-cut amount update data. The price-cut amount update data is distributed to all the mobile terminals 10, lines of which to the price-cut management server 40 are established.

Here, the processor 41 implements the function of the detecting unit 411 according to the processing in ACT 21 to ACT 33 in the second embodiment. The processor 41 implements the function of the distributing unit 412 according to the processing in ACT 36.

### [Third Information Processing]

The processor 11 of the mobile terminal 10, a line of which to the price-cut management server 40 is established, starts information processing of a procedure illustrated in a flowchart of FIG. 11 every time the processor 11 receives price-cut amount update data. In the following explanation, this information processing is referred to as third information processing.

In ACT 41, the processor 11 stores price-cut amount update data received via the wireless unit 14. In ACT 42, the processor 11 initializes a control flag F to “0”. Further, in ACT 43, the processor 11 sets an initial value of a subtraction counter d to “k”. “k” is the number of data of the received price-cut amount update data.

If ending the processing in ACT 41 to ACT 43, the processor 11 proceeds to ACT 44. In ACT 44, the processor 11 acquires a sticker ID from one price-cut amount update data. In the following explanation, the price-cut amount update data, from which the sticker ID was received, is referred to as processing target data.

In ACT 45, the processor 11 searches through the sticker buffer 121. In ACT 46, the processor 11 checks whether the sticker ID acquired from the processing target data is stored in the sticker buffer 121.

If the sticker ID acquired from the processing target data is not stored in the sticker buffer 121, the processor 11 skips processing in ACT 47 to ACT 52 explained below and proceeds to ACT 53. In ACT 53, the processor 11 counts down the subtraction counter d by “1”. In ACT 54, the processor 11 checks whether the subtraction counter d indicates “0”. If the subtraction counter d indicates a value larger than “0”, price-cut amount updated data, which is not processing target data yet, is present among the price-cut amount update data received from the price-cut management server 40. The processor 11 returns from ACT 54 to ACT 44. The processor 11 selects one out of the price-cut amount update data, which is not processing target data yet, and sets the price-cut amount update data as processing target data. The processor 11 acquires a sticker ID from the processing target data and checks whether the sticker ID is stored in the sticker buffer 121.

On the other hand, if the sticker ID acquired from the processing target data is stored in the sticker buffer 121, the processor 11 proceeds from ACT 46 to ACT 47. In ACT 47, the processor 11 checks the control flag F. If the control flag F is “0”, the processor 11 proceeds from ACT 47 to ACT 48. In ACT 48, the processor 11 changes the control flag F to “1”. If the control flag F was already changed to “1” in ACT 47, the processor 11 skips the processing in ACT 48.

If changing the control flag F to “1” in ACT 48 or skipping the processing in ACT 48, the processor 11 proceeds to ACT 49. In ACT 49, the processor 11 performs control to transmit an update event to the mobile server 30. The update event is wirelessly transmitted via the wireless unit 14 according to the control. The wirelessly-transmitted update event is received by the access point 70 and transmitted to the mobile server 30 through the communication network 60. The update event includes the transaction number stored in the processing in ACT 2 in FIG. 9 and the sticker ID and the updated price-cut amount configuring the processing target data.

The mobile server 30, which received the update event, executes fourth information processing explained below. The mobile server 30 returns an update completion command. The update completion commend includes an updated total amount.

In ACT 50, the processor 11, which controlled the transmission of the update event, waits for the update completion command. If receiving the update completion command from the mobile server 30 via the wireless unit 14, the processor 11 proceeds to ACT 51. In ACT 51, the processor 11 generates a price-cut amount update image. The price-cut amount update image is an image edited by the sticker image, the un-updated price-cut amount, and the updated price-cut amount configuring the processing target data, the sticker ID of which was stored in the sticker buffer 121. In ACT 52, the processor 11 stores the updated total amount acquired from the update completion command. If the updated total amount was stored before, the processor 11 stores the updated total amount acquired from the update completion command to overwrite the updated total amount.

If ending the processing in ACT 51 and ACT 52, the processor 11 proceeds to ACT 53. In ACT 53, the processor 11 counts down the subtraction counter d by “1”. In ACT 54, the processor 11 checks whether the subtraction counter d indicates “0”. If the subtraction counter d indicates a value larger than “0”, the processor 11 returns from ACT 54 to ACT 44. The processor 11 executes the processing in ACT 44 and subsequent acts in the same manner as explained above.

If the subtraction counter d indicates “0” in ACT 54, the processor 11 proceeds from ACT 54 to ACT 55. In ACT 55, the processor 11 checks the control flag F. If the control flag F is “0”, a price-cut amount update image is not generated. The processor 11 ends the third information processing.

If the control flag F is “1”, a price-cut amount update image is generated in ACT 51. The latest updated total amount is stored in ACT 52. The processor 11 proceeds from ACT 55 to ACT 56. In ACT 56, the processor 11 displays the price-cut amount update image on the touch panel 15. In ACT 57, the processor 11 displays the updated total amount on the touch panel 15. Then, the processor 11 ends the third information processing.

As explained above, the processor 11 generates a price-cut amount update image if the sticker ID included in the price-cut amount update data distributed from the price-cut management server 40 to the motile terminal 10 is stored in the sticker buffer 121. The processor 11 stores the updated price-cut amount received from the mobile server 30. The processor 11 displays the price-cut amount update image and the updated total amount on the touch panel 15. At this time, if two or more price-cut amount update images are stored, the processor 11 displays the two or more price-cut amount update images on the touch panel 15. Since the updated price-cut amount is overwritten, the processor 11 displays the latest updated price-cut amount.

Here, the processor 11 implements the function of the informing unit 112 according to the processing in ACT 41 to ACT 57 in the third information processing.

### [Fourth Information Processing]

The processor 31 of the mobile server 30, which received the update event from the mobile terminal 10, starts information processing of a procedure illustrated in a flowchart of FIG. 12. In the following explanation, this processing is referred to as fourth information processing.

In ACT 61, the processor 31 acquires the transaction number from the update event. In ACT 62, the processor 31 acquires the sticker ID from the update event. In ACT 63, the processor 31 searches for one data at a time in commodity sales data stored in the transaction file 39 having the transaction number acquired in ACT 61. In ACT 64, the processor 31 checks whether a sticker ID of the commodity sales data coincides with the sticker ID acquired in ACT 62. If the stickers ID do not coincide, the processor 31 skips processing in ACT 65 and ACT 66 explained below and proceeds to ACT 67.

In contrast, if the sticker ID of the commodity sales data coincides with the sticker ID acquired in ACT 62, the processor 31 proceeds to ACT 65. In ACT 65, the processor 31 updates the commodity sales data. Specifically, the processor 31 changes a price-cut amount of the commodity sales data to the updated price-cut amount included in the update event. The processor 31 recalculates an amount of the commodity sales data. If finishing updating the commodity sales data, the processor 31 proceeds to ACT 66. In ACT 66, the processor 31 recalculates a total price-cut amount and a total amount of the total data stored in the transaction file 39. If ending the processing in ACT 65 and ACT 66, the processor 31 proceeds to ACT 67.

As explained above, if the sticker ID of the commodity sales data does not coincide with the sticker ID acquired in ACT 62 or if ending the processing in ACT 65 and ACT 66 because the sticker IDs coincide, the processor 31 proceeds to ACT 67. In ACT 67, the processor 31 checks whether the search for the commodity sales data was finished. If the search was not finished, the processor 31 returns to ACT 63. The processor 31 executes the processing in ACT 63 and subsequent acts in the same manner as explained above.

If finishing the search for the commodity sales data stored in the transaction file 39 in this way, the processor 31 proceeds from ACT 67 to ACT 68. In ACT 68, the processor 31 acquires the total amount of the total data as an updated total amount. In ACT 69, the processor 31 transmits an update completion response command to the mobile terminal 10 at an update event transmission source. The update completion response command includes the updated total amount acquired in ACT 68. Then, the processor 31 ends the fourth information processing.

As explained above, the processor 31 of the mobile server 30, which received the update event, changes a price-cut amount of commodity sales data based on a price-cut sticker, a price-cut amount of which was changed according to the elapse of time, from an un-updated price-cut amount to an updated price-cut amount and recalculates an updated total amount. The processor 31 transmits an update completion response command including the updated total amount to the mobile terminal 10 at the update event transmission source.

### [Action Effects of the Store System]

As explained in detail above, if a price-cut sticker is stuck to a purchase commodity registered by the consumer operating the mobile terminal 10, a sticker ID of the price-cut sticker is stored in the sticker buffer 121 of the mobile terminal 10. The sticker ID stored in the sticker buffer 121 is retained until checkout of the consumer operating the mobile terminal 10 ends.

On the other hand, if a price-cut amount specified by the price-cut sticker is updated according to the elapse of time, the price-cut management server 40 distributes price-cut amount update data to the mobile terminal 10. The price-cut amount update data includes the sticker ID of the price-cut sticker having the updated price-cut amount, a sticker image of the price-cut sticker, an un-updated price-cut amount, and an updated price-cut amount. The price-cut amount update data is distributed to all the mobile terminals 10, communication of which with the mobile server 30 and the price-cut management server 40 is established.

Therefore, the mobile terminal 10 used by the consumer not finishing the checkout can receive the price-cut amount update data. If receiving the price-cut amount update data including the sticker ID stored in the sticker buffer 121, the mobile terminal 10 displays a price-cut amount update image and an updated total amount on the touch panel 15.

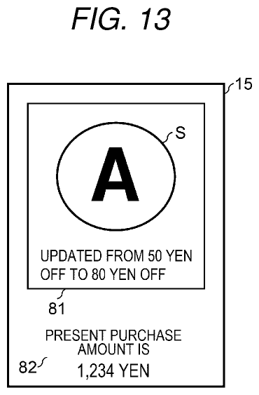

FIG. 13 is a screen example of the touch panel 15 on which a price-cut amount update image 81 and an updated total amount 82 are displayed. The price-cut amount update image 81 indicates that a price-cut amount specified by the price-cut sticker S attached to a purchase commodity registered by the consumer was updated from an un-updated price-cut amount of 50 yen to an updated price-cut amount of 80 yen. The updated total amount 82 indicates that a purchase amount after the price-cut amount specified by the price-cut sticker S was updated is 1,234 yen.

The consumer can learn, with the price-cut amount update image 81 displayed on the touch panel 15, that an amount cut by the price-cut sticker S stuck to the purchase commodity was increased from 50 yen to 80 yen. The consumer can learn that the purchase amount was changed to 1, 234 yen because the price-cut amount was increased.

As explained above, according to the first embodiment, from when a consumer puts a commodity in a shopping basket or the like in the selling floor until the consumer performs checkout in the checkout place, even if an amount of a price-cut decided by a price-cut sticker stuck to the commodity was changed according to the elapse of time, it is possible to inform the consumer in real time that the amount of the price-cut was changed. It is also possible to inform a total amount after the price-cut amount change in real time.

### Second Embodiment

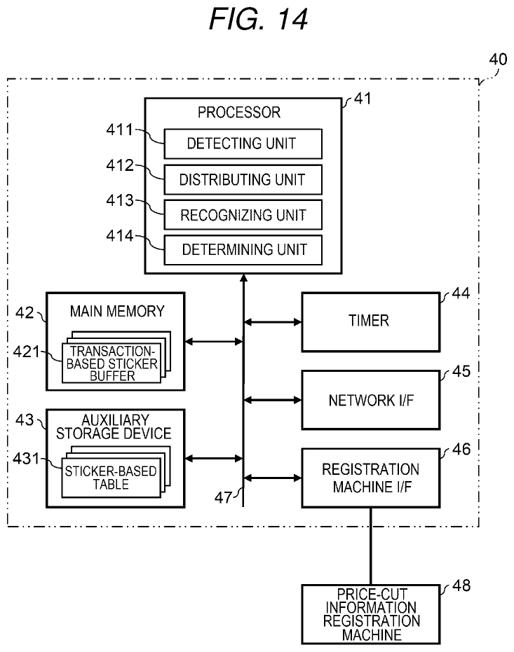

A second embodiment is explained with reference to FIGS. 14 to 17.

Note that the configurations of the store system 100, the mobile server 30, and the mobile terminal 10 are the same as the configurations in the first embodiment. Therefore, FIGS. 1 to 6 are applied as they are in the second embodiment as well and explanation of the configurations is omitted.

### [Explanation of the Price-Cut Management Server]

FIG. 14 is a block diagram illustrating a main part circuit configuration of the price-cut management server 40 in the second embodiment. In FIG. 14, portions common to the portions illustrated in FIG. 7 explained in the first embodiment are denoted by the same reference numerals and signs. As it is seen if FIG. 7 and FIG. 14 are compared, the price-cut management server 40 in the second embodiment is different from the price-cut management server 40 in the first embodiment in that a part of the storage region of the main memory 42 is set as a region of a transaction-based sticker buffer 421 and that the processor 41 has functions of a recognizing unit 413 and a determining unit 414.

The transaction-based sticker buffer 421 is generated for each of the mobile terminals 10, communication of which with the price-cut management server 40 is established. The transaction-based sticker buffer 421 is a region for temporarily storing a sticker ID of a price-cut sticker stuck to a purchase commodity registered by the mobile terminal 10.

The recognizing unit 413 is a function of recognizing, for each of the mobile terminals 10, communication of which is established via the access point 70, a price-cut sticker read by the reading sensor 19 of the mobile terminal 10. The determining unit 414 is a function of determining, as a transmission destination, the mobile terminal 10 that read a price-cut sticker, fluctuation of a price-cut amount specified by the price-cut sticker being detected by the detecting unit 411. The distributing unit 412 distributes information indicating that the price-cut amount specified by the price-cut sticker fluctuated, that is, price-cut amount update data to the motile terminal 10 determined as the transmission destination by the determining unit 414.

### [Explanation of an Operation of the Store System] [First Information Processing]

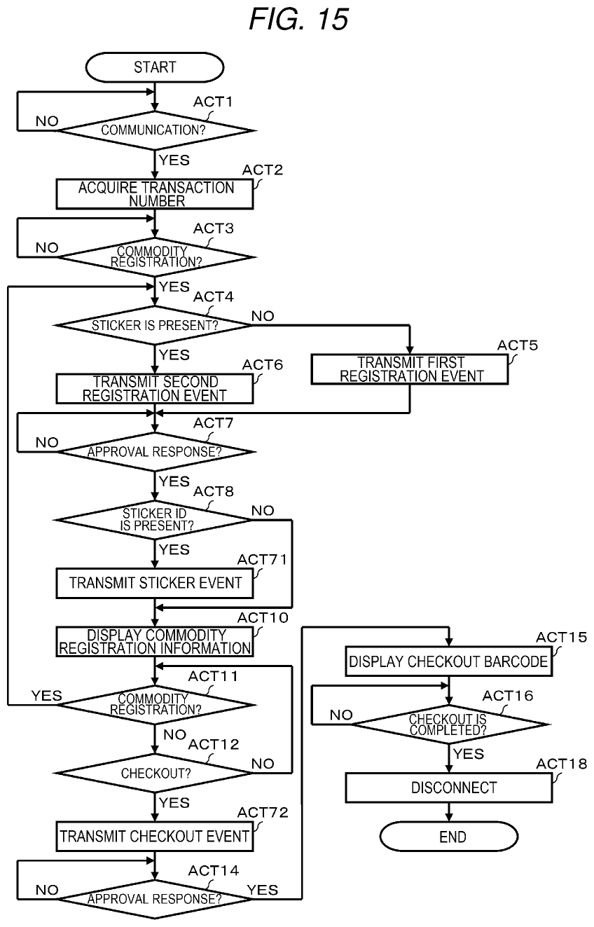

FIG. 15 is a flowchart illustrating a main part procedure of first information processing executed by the processor 11 of the mobile terminal 10 in the second embodiment. Note that portions common to the portions illustrated in FIG. 9 of the same processing explained in the first embodiment are denoted by the same reference signs and detailed explanation of the portions is omitted.

In ACT 1 to ACT 8, the processor 11 executes the same processing as the processing in the first embodiment. That is, the processor 11 of the mobile terminal 10, communication of which with the mobile server 30 is established via the access point 70, stores a transaction number and, thereafter, waits for registration of a purchase commodity. If a purchase commodity was registered, the processor 11 transmits a first registration event to the mobile server 30 if an image of a price-cut sticker was not read in the registration. If an image of a price-cut sticker was read, the processor 11 transmits a second registration event to the mobile server 30.

The processor 11, which transmitted the first registration event or the second registration event, waits for an approval response command. If receiving an approval response command from the mobile server 30, the processor 11 checks whether a sticker ID is present in commodity sales data included in the approval response command. If a sticker ID is absent, the processor 11 executes the processing in ACT 10 to ACT 12 in the same manner as explained in the first embodiment. That is, the processor 11 displays commodity registration information on the touch panel 15 and waits for the next commodity registration to be performed or checkout to be instructed.

In contrast, if a sticker ID is present in the commodity sales data, the processor 11 proceeds from ACT 8 to ACT 71. In ACT 71, the processor 11 controls transmission of a sticker event. According to the control, the sticker event is wirelessly transmitted via the wireless unit 14. The wirelessly-transmitted sticker event is received by the access point 70 and transmitted to the price-cut management server 40 through the communication network 60. The sticker event includes the sticker ID present in the commodity sales data. The sticker event includes the transaction number stored in the processing in ACT 2. The processor 11, which transmitted the sticker event, executes the processing in ACT 10 to ACT 12 in the same manner as explained above.

The processor 11, which detected the checkout instruction in ACT 12, proceeds to ACT 72. In ACT 72, the processor 11 controls transmission of a checkout event. According to the control, the checkout event is wirelessly transmitted via the wireless unit 14. The wirelessly-transmitted checkout event is received by the access point 70 and transmitted to the mobile server 30 and the price-cut management server 40 through the communication network 60. The checkout event includes the transaction number stored in ACT 2. As explained above, in the second embodiment, the checkout event is transmitted not only to the mobile server 30 but also to the price-cut management server 40.

The processor 11, which controlled the transmission of the checkout event, executes the processing in ACT 14 to ACT 16 in the same manner as explained in the first embodiment. That is, the processor 11 waits for an approval response command. If receiving the approval response command from the mobile server 30, the processor 11 displays a checkout barcode on the touch panel 15. Thereafter, if receiving a checkout completion command from the mobile server 30, the processor 11 proceeds to ACT 18. That is, the processor 11 disconnects the line to the mobile server 30 and ends the first information processing.

As explained above, if a price-cut sticker is stuck to a purchase commodity, the processor 11 of the mobile terminal 10 transmits a sticker event including a sticker ID of the price-cut sticker and a transaction number to the price-cut management server 40. The processor 11 transmits the checkout event including the transaction number not only to the mobile server 30 but also to the price-cut management server 40.

### [Fifth Information Processing]

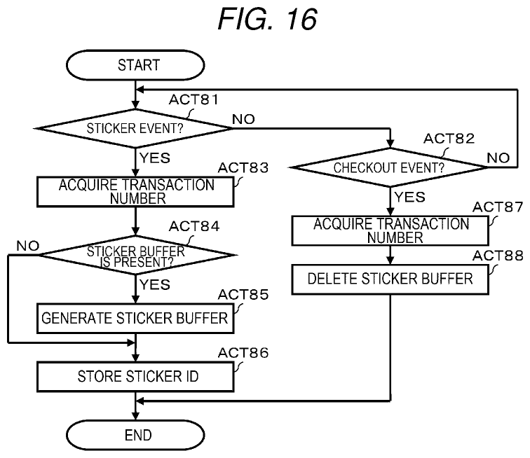

The processor 41 of the price-cut management server 40 executes information processing of a procedure illustrated in a flowchart of FIG. 16. In the following explanation, this information processing is referred to as fifth information processing.

In ACT 81, the processor 41 checks whether a sticker event was received. If a sticker event was not received, in ACT 82, the processor 41 checks whether a checkout event was received. If a checkout event was not received, the processor 41 returns to ACT 81. In this way, in ACT 81 and ACT 82, the processor 41 waits for a sticker event to be received or a checkout event to be received.

If receiving a sticker event in the waiting state in ACT 81 and ACT 82, the processor 41 proceeds from ACT 81 to ACT 83. In ACT 83, the processor 41 acquires a transaction number from the sticker event. In ACT 84, the processor 41 checks whether the transaction-based sticker buffer 421 in which the transaction number is set is present. If the transaction-based sticker buffer 421 is absent, the processor 41 advances from ACT 84 to ACT 85. In ACT 85, the processor 41 generates, in the main memory 42, the transaction-based sticker buffer 421 in which the transaction number is set. In ACT 86, the processor 41 describes a sticker ID acquired from the sticker event in the transaction-based sticker buffer 421.

If the transaction-based sticker buffer 421 including the transaction number acquired from the sticker event is already present in the main memory 42, the processor 41 proceeds from ACT 84 to ACT 86. In ACT 86, the processor 41 describes the sticker ID acquired from the sticker event in the transaction-based sticker buffer 421. Then, the processor 41 ends the fifth information processing performed if the sticker event was received.

On the other hand, if a checkout event was received, the processor 41 proceeds from ACT 82 to ACT 87. In ACT 87 the processor 41 acquires a transaction number from the checkout event. Since the transaction-based sticker buffer 421 in which the transaction number is set is already generated in the main memory 42, the processor 41 proceeds to ACT 88. In ACT 88, the processor 41 deletes, from the main memory 42, the transaction-based sticker buffer 421 in which the transaction number is set. Then, the processor 41 ends the fifth information processing performed if the checkout event was received.

As explained above, the processor 41 of the price-cut management server 40 stores, every time the processor 41 receives a sticker event from the mobile terminal 10, a sticker ID included in the sticker event in the transaction-based sticker buffer 421 in which a transaction number stored in the mobile terminal 10 is set. The sticker ID is a sticker ID of a price-cut sticker read by the reading sensor 19 of the mobile terminal 10. The transaction-based sticker buffer 421 is deleted if checkout of a consumer using the mobile terminal 10 that stores the transaction number set in the transaction-based sticker buffer 421 ends.

Here, the processor 41 implements the function of the recognizing unit 413 according to the processing in ACT 81 to ACT 88 in FIG. 16.

### [Second Information Processing]

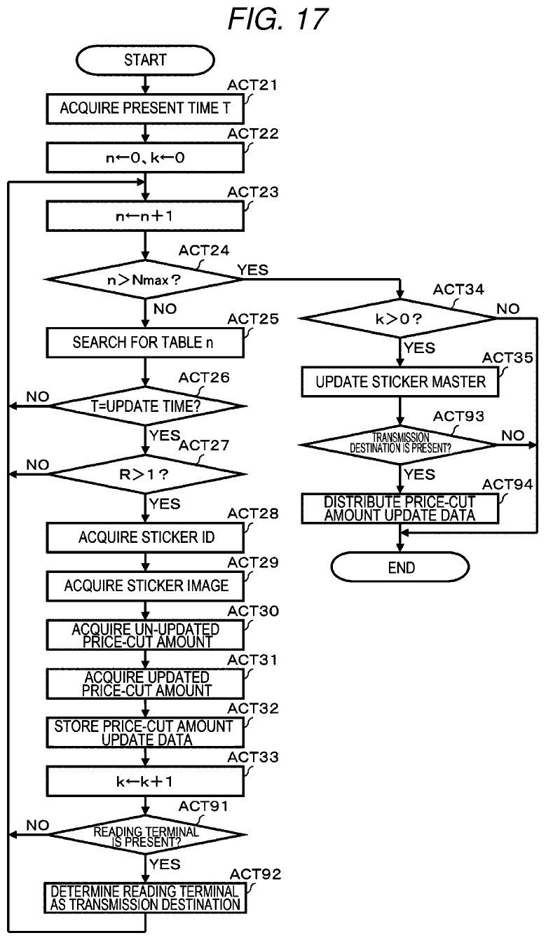

FIG. 17 is a flowchart illustrating a main part procedure of second information processing executed by the processor 41 of the price-cut management server 40. The second information processing in the second embodiment is different from the second information processing in the first embodiment in processing after ACT 33 and processing after ACT 35. The other processing in ACT 21 to ACT 33 and processing in ACT 34 and ACT 35 performed after the counter n indicates a value larger than the upper limit value Nmax are the same as the processing in the first embodiment. Therefore, explanation of the processing is omitted here.

In the second embodiment, if the record number R of updated pair data, update time of which is the present time T, is “2” or more, the processor 41, which ended the processing in ACT 28 to ACT 33, proceeds to ACT 91. In ACT 91, the processor 41 checks whether the mobile terminal 10 in which a price-cut sticker identified by the sticker ID included in the price-cut amount update data is registered is present. Specifically, the processor 41 searches for all transaction-based sticker buffers 421 generated in the main memory 42 and detects the transaction-based sticker buffer 421 in which the sticker ID included in the price-cut amount update data is described. The mobile terminal 10 that stores a transaction number set in the detected transaction-based sticker buffer 421 is the mobile terminal 10 that read, with the reading sensor 19, the price-cut sticker identified by the sticker ID included in the price-cut amount update data. In the following explanation, this mobile terminal 10 is referred to as reading terminal. The processor 41 proceeds to ACT 92. In ACT 92, the processor 41 determines the reading terminal as a transmission destination of the price-cut amount update data.

If the processor 41 cannot detect the reading terminal or determines the reading terminal as the transmission destination of the price-cut amount update data in ACT 92, the processor 41 returns to ACT 23. The processor 41 executes the processing in ACT 23 and subsequent acts in the same manner as explained above.

Therefore, the mobile terminal 10, which read, with the reading sensor 19, the price-cut sticker identified by the sticker ID included in the price-cut amount update data, is determined as the transmission destination of the price-cut amount update data.

On the other hand, the processor 41, which requested the mobile server 30 to update the sticker master 38 with the price-cut amount update data in ACT 35, proceeds to ACT 93. In ACT 93, the processor 41 checks whether the mobile terminal 10 determined as the transmission destination of the price-cut amount update data is present. If the mobile terminal 10 determined as the transmission destination is present, the processor 41 proceeds to ACT 94. In ACT 94, the processor 41 distributes the price-cut amount update data stored in the transmission buffer to the mobile terminal 10 determined as the transmission destination.

Here, the processor 41 implements the function of the determining unit 414 according to the processing in ACT 91 and ACT 92 in FIG. 17. The processor 41 implements the function of the distributing unit 412 according to the processing in ACT 93 and ACT 94.

As explained in detail above, according to the second embodiment, the price-cut management server 40 distributes the price-cut amount update data only to the mobile terminal 10 that read a price-cut sticker, a price-cut amount of which fluctuated, among the mobile terminals 10, communication of which is established via the access point 70. Therefore, compared with the first embodiment in which the price-cut amount update data is distributed to all the mobile terminals 10, communication of which is established, it is possible to reduce a communication traffic amount between the price-cut management server 40 and the mobile terminal 10. Since the price-cut amount update data is not distributed to the mobile terminal 10 that did not read the price-cut sticker, the price-cut amount of which fluctuated, it is possible to reduce a load of information processing executed by the processor 11 of the mobile terminal 10.

Moreover, since the sticker buffer 121 of the mobile terminal 10 is unnecessary, there is also an advantage that a memory capacity of the mobile terminal 10 can be reduced.

### Other Embodiments

In the embodiments explained above, as illustration, a price-cut amount of a price-cut target commodity is changed according to the remaining time until an expiration date. Even if a commodity for which a best-before date or stock disposal is set in units of the number of days is set as a price-cut target commodity, a price-cut amount is likely to be changed halfway in shopping in a store opening for 24 hours. Even in such a case, the embodiments can be applied by changing update time of the sticker-based table 431 to an update date.

In the embodiments, a price-cut amount update data, which is information indicating that a price-cut amount specified by a sticking object fluctuated, is data including a sticker ID and a sticker image of a price-cut sticker and an un-updated price-cut amount and an updated price-cut amount. The price-cut amount update data only has to be at least information with which a consumer can identify the price-cut sticker and information with which the consumer can learn a price-cut amount after update.

The informing unit 112 included in the mobile terminal 10 is not limited to the unit that displays the price-cut amount update image 81. For example, voice indicating that the price-cut amount was updated may be emitted from the speaker 16. The price-cut amount update image 81 is not limited to that illustrated in FIG. 13. For example, the price-cut amount after the update is highlighted by using thick characters or changing a color. Alternatively, the price-cut amount change image 81 is flashed to call a consumer's attention.

In the first embodiment, the processor 41 of the price-cut management server 40 adds, after the processing in ACT 35 in FIG. 10, processing for acquiring a sticker ID stored in the sticker buffer 121 included in the mobile terminal 10, a line of which is established via the access point 70. In the processing in ACT 36, the processor 41 sets, as a transmission destination, the mobile terminal 10 in which the sticker ID included in the price-cut amount update data is stored in the sticker buffer 121 and distributes the price-cut amount update data. By adopting such a configuration, an effect of being able to reduce a communication traffic amount is achieved as in the second embodiment.

In the store system 100, the checkout machine 20 may be omitted by making it possible to directly perform checkout in the mobile terminal 10. The function of the mobile server 30 and the function of the price-cut management server 40 may be realized by one server.

Besides, although several embodiments are explained above, these embodiments are presented as examples and are not intended to limit the scope of disclosure. These new embodiments can be implemented in other various forms. Various omissions, substitutions, and changes can be made without departing from the spirit of the disclosure. These embodiments and modifications thereof are included in the scope of the disclosure and included in the disclosure described in the claims and a scope of equivalents of the disclosure.

What is claimed is:

1. A store system, comprising:
a server configured to manage a price-cut amount specified by a sticking object on a commodity; and
an information terminal operated by a consumer visiting a store that sells the commodity, wherein
the server includes:
a detector configured to detect that the price-cut amount specified by the sticking object fluctuated according to elapse of time; and
a distributing component configured to distribute, to the information terminal, communication of which with the server is established, information indicating that the price-cut amount specified by the sticking object fluctuated, and
the information terminal includes:
a communication controller configured to establish communication with the server until checkout of a commodity purchased in the store by the consumer visiting the store ends; and
an informing component configured to inform, based on the information received from the server, that the price-cut amount specified by the sticking object fluctuated.

2. The store system according to claim 1, wherein
the information terminal further includes a reading component configured to read the sticking object stuck to the commodity, and
the informing component informs, based on the information received from the server, that the price-cut amount specified by the sticking object read by the reading component fluctuated.

3. The store system according to claim 1, wherein
the information terminal further includes a reading component configured to read the sticking object stuck to the commodity,
the server further includes:
a recognizing component configured to recognize, for each the information terminal, the communication of which is established, the sticking object read by the reading component of the information terminal; and
a determining component configured to determine, as a transmission destination, the information terminal that read the sticking object, the fluctuation of the price-cut amount specified by the sticking object being detected by the detector, and
the distributing component distributes the information to the information terminal determined as the transmission destination by the determining component.

4. The store system according to claim 1, wherein the informing component is further configured to inform, based on the information received from the server, that the price-cut amount specified by the sticking object increased.

5. The store system according to claim 1, wherein the informing component is further configured to inform, based on the information received from the server, that the price-cut amount specified by the sticking object decreased.

6. The store system according to claim 1, wherein the server further includes a commodity master database comprising an aggregate of commodity master data generated for each commodity.

7. The store system according to claim 1, wherein the server further includes a sticker master database comprising an aggregate of sticker master data generated for each of types of price-cut stickers on price-cut target commodities.

8. A server that manages a price-cut amount specified by a sticking object on a commodity and is capable of communicating with an information terminal operated by a consumer visiting a store that sells the commodity, the server comprising:
a detector configured to detect that the price-cut amount specified by the sticking object fluctuated according to elapse of time; and
a distributing component configured to distribute, to the information terminal, communication of which with the server is established, information indicating that the price-cut amount specified by the sticking object fluctuated.

9. The server according to claim 8, further comprising:
a recognizing component configured to recognize, for each the information terminal, the communication of which is established, the sticking object read by the reading component of the information terminal; and
a determining component configured to determine, as a transmission destination, the information terminal that read the sticking object, the fluctuation of the price-cut amount specified by the sticking object being detected by the detector, wherein
the distributing component distributes the information to the information terminal determined as the transmission destination by the determining component.

10. The server according to claim 8, wherein the distributing component is further configured to distribute, to the information terminal, communication of which with the server is established, information indicating that the price-cut amount specified by the sticking object increased.

11. The server according to claim 8, wherein the distributing component is further configured to distribute, to the information terminal, communication of which with the server is established, information indicating that the price-cut amount specified by the sticking object decreased.

12. The server according to claim 8, further comprising:
a commodity master database comprising an aggregate of commodity master data generated for each commodity.

13. The server according to claim 8, further comprising:
a sticker master database comprising an aggregate of sticker master data generated for each of types of price-cut stickers on price-cut target commodities.

14. A method for a server that manages a price-cut amount specified by a sticking object on a commodity and is capable of communicating with an information terminal operated by a consumer visiting a store that sells the commodity, the method comprising:
detecting that the price-cut amount specified by the sticking object fluctuated according to elapse of time; and
distributing, to the information terminal, communication of which with the server is established, information indicating that the price-cut amount specified by the sticking object fluctuated.

15. The method according to claim 14, further comprising:
recognizing, for each the information terminal, the communication of which is established, the sticking object read by the information terminal;
determining, as a transmission destination, the information terminal that read the sticking object, the fluctuation of the price-cut amount specified by the sticking object being detected; and
distributing the information to the information terminal determined as the transmission destination.

16. The method according to claim 14, further comprising:
distributing, to the information terminal, communication of which with the server is established, information indicating that the price-cut amount specified by the sticking object increased.

17. The method according to claim 14, further comprising:
distributing, to the information terminal, communication of which with the server is established, information indicating that the price-cut amount specified by the sticking object decreased.

18. The method according to claim 14, further comprising:
accessing a commodity master database comprising an aggregate of commodity master data generated for each commodity.

19. The method according to claim 14, further comprising:
accessing a sticker master database comprising an aggregate of sticker master data generated for each of types of price-cut stickers on price-cut target commodities.
